(19) United States
(12) Patent Application Publication
(10) Pub. No.: US 2009/0195054 A1
(43) Pub. Date: Aug. 6, 2009

(54) Wheel frame structure

(76) Inventor: Fang-Li Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,370

(22) Filed: Feb. 6, 2008

(51) Int. Cl. B60B 5/02

(52) U.S. Cl. 301/64.704

(57) ABSTRACT

A frame of a wheel includes a ring, several spokes, and a hub; the ring has several connecting members on an inward side, and the spokes each have a connecting hole on each of first and second ends thereof, and are each joined to one corresponding said connecting member at their first ends with threaded fixing elements; the hub includes left and right holding members, each of which has several hollow receiving portions on an inner side thereof; each holding member has a connecting hole extending through each of the hollow receiving portions; the left holding member is joined to the right holding member with the hollow receiving portions thereof adjoining the hollow receiving portions of the right holding member respectively; the spokes are securely joined to the hub, with their second ends being received in the hollow receiving portions, with threaded fixing elements.

### BACKGROUND OF THE INVENTION

1. Field of the Invention

The present invention relates to a frame of a wheel, more particularly one, which consists of several hub separable from its ring and its hub; therefore, the user is allowed to change only the damaged parts instead of the whole wheel frame the wheel frame is only partially damaged or deformed, thus helping to reduce consumption of natural resources.

2. Brief Description of the Prior Art

Most kinds of currently existing land vehicles have wheels, which are a circular device capable of rotating on its axis to facilitate movement and transportation.

A kind of wheel consists of a frame, and an elastic tire; the frame includes a ring, a hub, and several spokes arranged between the ring and the hub to strengthen the ring, and the tire is secured around an outer side of the ring of the frame.

Such a wheel frame structure has a drawback: all of the parts of the wheel frame are formed together, and can't be separated from each other therefore the whole wheel frame has to be replaced with a good one even if the wheel frame is only partially damaged or deformed. Consequently, such a wheel frame isn't economical to use, and its use cannot help to reduce consumption of natural resources.

Therefore, it is a main object of the present invention to provide an improvement on a wheel frame to overcome the above problem.

### SUMMARY OF THE INVENTION

A wheel frame according to an embodiment of the present invention consists of a ring, several spokes, and a hub. The ring has several connecting members on an inward side, and the spokes each have a connecting hole on each of first and second ends, and are each joined to one corresponding said connecting member at the first end by means of a threaded fixing element. The hub includes left and right holding members, each of which has several hollow receiving portions on an inner side; each holding member has a connecting hole extending through each of its hollow receiving portions. The left holding member is joined to the right one with its hollow receiving portions adjoining those of the right holding member respectively. The spokes are securely joined to the hub, with their second ends being received in the hollow receiving portions, and threaded fixing elements being passed through the connecting holes. Therefore, the user can change only the damaged parts instead of the whole wheel frame if the frame is only partially damaged or deformed.

### BRIEF DESCRIPTION OF THE DRAWINGS

The present invention will be better understood by referring to the accompanying drawings, wherein:

FIG. 1 is an exploded perspective view of the present invention,

FIG. 2 is a sectional view of the present invention,

FIG. 3 is a front view of the present invention, and

FIG. 4 is a front view of another embodiment of the present invention.

### DETAILED DESCRIPTION OF THE PREFERRED EMBODIMENTS

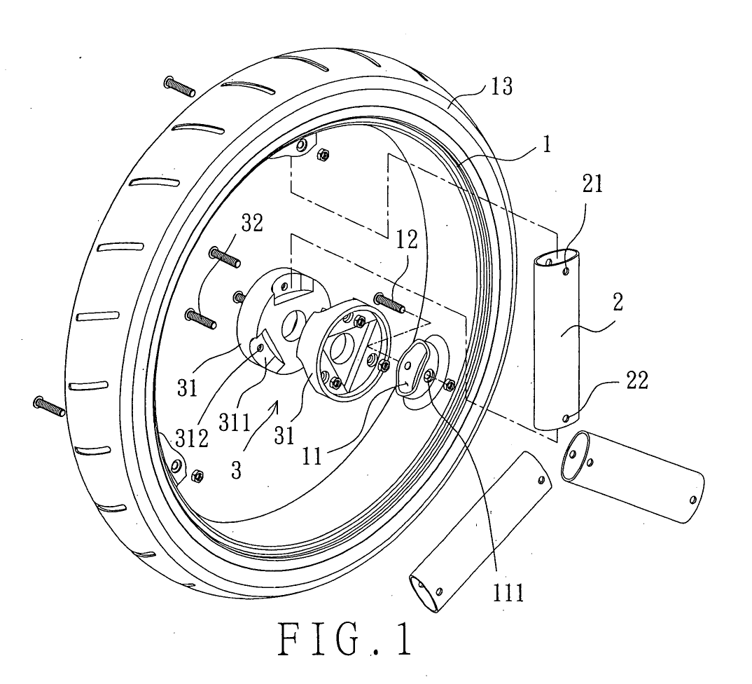

Referring to FIG. 1, a preferred embodiment of a frame of a wheel in the present invention consists of a ring 1, several spokes 2, and a hub 3.

The ring 1 has several connecting members 11 on an inward side thereof. Each of the connecting members 11 has opposing connecting holes 111 on two sides thereof.

The spokes 2 come in various shapes, and each have a connecting hole 21 on a first end thereof, and a connecting hole 22 on a second end thereof. Each of the spokes 2 is joined to one corresponding said connecting member 11 of the ring 1 at the first end thereof by means of a threaded fixing element 12, which is passed through the connecting hole 21 as well as the opposing connecting holes 111 of the corresponding connecting member 11.

The hub 3 consists of left and right holding members 31; each of the holding members 31 has several hollow receiving portions 311 on an edge of an inner side thereof, and a connecting hole 312 extending through each of the hollow receiving portions 311 thereof. The left holding member 31 is joined to the right holding member 31 with the hollow receiving portions 311 thereof adjoining the hollow receiving portions 311 of the right holding member 31 respectively.

The spokes 2 are securely joined to the hub 3, with the second ends thereof being received in the hollow receiving portions 311 of the holding members 31 of the hub 3, by means of threaded fixing elements 32, which are passed through the connecting holes 21 of the second ends of the spokes 2 as well as the connecting holes 312 of the hub 3.

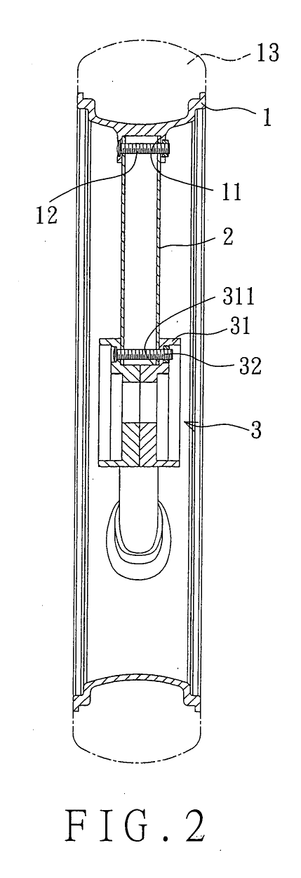

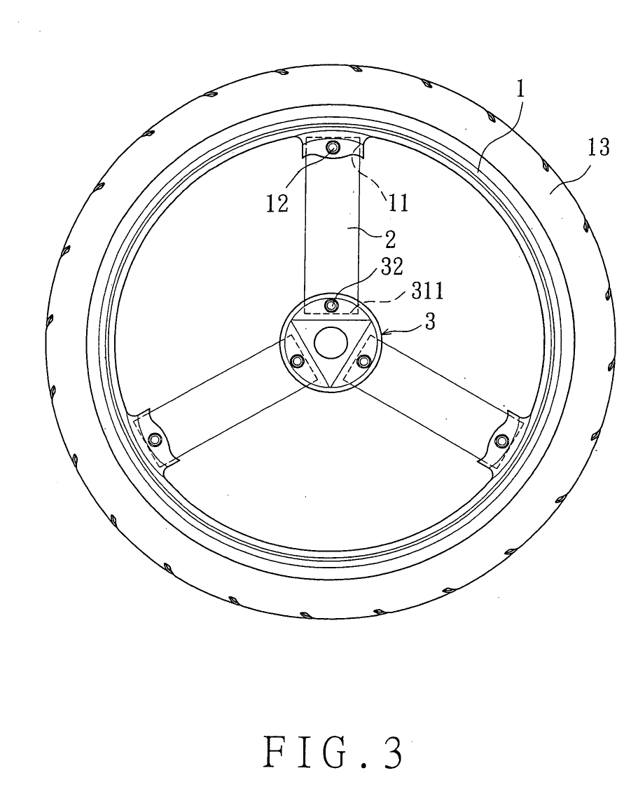

In assembly, referring to FIGS. 2 and 3, first the spokes 2 are securely joined to the connecting members 11 on the inner side of the ring 1, with the threaded fixing elements 12 being passed through the connecting holes 111 and 21. Next, the left and the right holding members 31 are positioned together so that the second ends of the spokes 2 are received in the hollow receiving portions of the both the holding members 31. Finally, the threaded fixing elements 32 are passed through the connecting holes 312 of the holding members 31 as well as the connecting holes 22 of the second ends of the pokes 2; thus, the hub 3 is securely joined to the spokes 2.

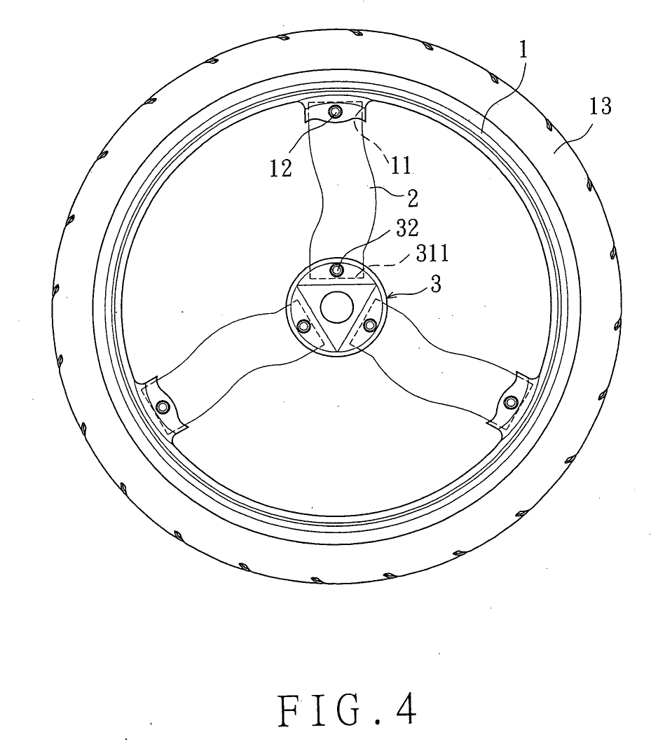

Furthermore, the wheel frame of the present invention can be equipped with other spokes 2 having a different shape from those of the above preferred embodiment, as shown in FIG. 4.

From the above description, it can be seen that the present invention has an advantage over the prior art: the user is allowed to change only the damaged parts instead of the whole wheel frame if the wheel frame is only partially damaged/deformed, thus helping to reduce consumption of natural resources. Consequently, the wheel frame of the present invention is relatively economical to use.

What is claimed is:

1. Structure of a frame of a wheel, comprising
a ring, the ring having a plurality of connecting members on an inward side thereof; each of the connecting members having opposing connecting holes on two sides thereof;
a plurality of spokes, each of the spokes having a connecting hole on each of first and second ends thereof; each of the spokes being joined to one corresponding said connecting member at the first end thereof by means of a threaded fixing element passed through the connecting hole of the first end thereof and the connecting holes of said corresponding connecting member; and
a hub, the hub including left and right holding members; each of the holding members having a plurality of hollow receiving portions on an inner side thereof; each of the holding members having a connecting hole extending through each of the hollow receiving portions thereof;
the left holding member being joined to the right holding member with the hollow receiving portions thereof adjoining the hollow receiving portions of the right holding member respectively;
the spokes being securely joined to the hub, with the second ends being received in the hollow receiving portions of the holding members, by means of threaded fixing elements passed through the connecting holes of their second ends and the connecting holes of the hub.
